(19) United States
(12) Patent Application Publication
(10) Pub. No.: US 2013/0221109 A1
(43) Pub. Date: Aug. 29, 2013

(54) WIRELESS IC TAG, PROCESS FOR MANUFACTURING THE SAME, AND DIE FOR MOLDING WIRELESS IC TAG

(71) Applicant: MITOMO CORPORATION, (US)

(72) Inventor: Kikuo Kaga, Tokyo (JP)

(73) Assignee: MITOMO CORPORATION, Kanagawa (JP)

(21) Appl. No.: 13/693,104

(22) Filed: Dec. 4, 2012

(30) Foreign Application Priority Data
Feb. 24, 2012 (JP) 2012-38642

(51) Int. Cl. G06K 19/077; G06K 19/07

(52) U.S. Cl. CPC G06K 19/07749; G06K 19/0723
USPC 235/492; 264/272.15; 425/129.1

(57) ABSTRACT

A wireless IC tag is manufactured by embedding a tag substrate in a columnar outer shell body, in which circumferential protrusions are formed on the peripheries of both end portions of the columnar outer shell body. The wireless IC tag is manufactured by implementing injection molding, while supporting the upper and under surfaces of the tag substrate by supporting members so that the tag substrate is held in the central position in a die and positioning both the lateral sides of the tag substrate by positioning members, subsequently moving the supporting members and the positioning members backward from the die on the way of the molding, and then continuing the injection molding.

### BACKGROUND OF THE INVENTION

1. Field of the Invention

The present invention relates to wireless IC tag for performing writing and reading data regarding various products, a process for manufacturing said wireless IC tag, and a die for molding said wireless IC tag. In particular, the present invention relates to a columnar wireless IC tag which can be fed through a cylindrical releasing outlet, a process for manufacturing said wireless IC tag, and a die for molding said wireless IC tag.

2. Prior Art

A method for implementing quality management for a product, which normally exists in any state of liquid, viscous or semi-solid during the manufacturing, such as fresh concrete and a thermoplastic resin, by means of incorporating an IC tag having been written with various data in advance in the product before said product has been hardened, and then reading said data or writing new data from/to the IC tag incorporated in the hardened product via radio communication, has already been known.

The wireless IC tag as described above is prepared by molding a tag substrate, to which a capacitor, an IC chip, an antenna coil and so on are mounted, with a resin material to shape the molded tag substrate into a small massive form, said may be global, cylindrical, columnar or the like. The prepared wireless IC tag is then introduced into the material for building a construction before said material has been hardened. Note that said tag substrate (chip) must be enclosed in the central position of the molded mass of a resin and is caused to face in a predetermined direction in order to effectively perform writing and reading operations of signals via radio communication. Besides, an IC tag provided with plural small recesses and/or grooves on its outer shell body formed of a resin for aiming at enhancing the contact of the IC tag to the material for building a construction without causing gaps therebetween while keeping appropriate adhesiveness to each other, when the IC tag is introduced into the material for building a construction, is also known.

### REFERENCES OF THE PRIOR ART

### Patent Documents

[Patent Document 1]: Japanese Unexamined Patent Application Publication No. 2006-145385

[Patent Document 2]: Japanese Unexamined Patent Application Publication No. 2009-282688

### SUMMARY OF THE INVENTION

A wireless IC tag manufactured by enclosing an IC tag substrate with a resin material by molding, burrs having irregular shapes are often formed on the lateral portion of the molded wireless IC tag. When the wireless IC tag being in the state having such burrs is supplied to an IC tag feeding machine, the wireless IC tag may be caught to cause clogging in a carrying passage or at the releasing outlet of the IC tag feeding machine due to protrusions of the burrs. Such burrs are apt to be formed mainly on the outer surface of the tag portion that faces a resin-releasing outlet of a die for molding. In particular, when the wireless IC tag is applied to an IC tag feeding machine of the vertical-type, in which a tag-releasing hose is attached to a releasing outlet provided at the tip of the feeding machine to blow away the wireless IC tag by virtue of compressed air, gaps are caused in between the inner wall of the releasing outlet or the releasing hose and the wireless IC tag due to said protrusions of the burrs, which causes leakage of the compressed air to reduce releasing power to blow away the wireless IC tag. As a result, there might be a case that the wireless IC tag cannot be released from the releasing outlet.

Besides, when the wireless IC tag is manufactured by molding with a resin, it is required to mold it so that a tag substrate is enclosed in place relative to the periphery of the outer shell body made of a resin, that is, typically the tag substrate is fixed accurately in the central position of the outer shell body. Otherwise, such a problem that writing and reading of data signals via radio communication cannot be done effectively may be caused, because said position of the tag substrate is deviated or the angle of the rectangular tag substrate is inclined relative to the central axis line of the outer shell body.

Therefore, it is an object of the present invention to provide a wireless IC tag, which will not get stuck or cause leakage of compressed air in the tag carrying passage or at the tag releasing outlet using compressed air of the IC tag feeding machine, and wherein the tag substrate must be enclosed in an accurate position and in a right direction relative to the outer shell body.

It is a further object of the present invention to provide a process for manufacturing the wireless IC tag, which allows to mold the outer shell body of the wireless IC tag so that an IC tag substrate is positioned in an accurate position and in a right direction relative to said outer shell body.

It is a still further object of the present invention to provide a die for molding the wireless IC tag, said die can form the outer shell body of the IC tag so as to arrange the tag substrate of the IC tag in an accurate position and in a right direction relative to said outer shell body.

The wireless IC tag according to the present invention is characterized by enclosing a tag substrate in a columnar outer shell body and forming circumferential protrusions on the peripheries of both end portions of said columnar outer shell body.

According to one embodiment of the wireless IC tag of the present invention, the wireless IC tag in which the ridges of said circumferential protrusions are round chamfered is provided in claim 1 of this patent application.

According to another embodiment of the wireless IC tag of the present invention, the wireless IC tag in which a plurality of concave grooves extending in the axial direction of said columnar outer shell body are formed on the body section of said outer shell body is provided in claim 1 or 2 of this patent application.

According to a further embodiment of the wireless IC tag of the present invention, the wireless IC tag in which a mark indicating information on the manufacturing is engraved on the columnar outer shell body is provided in claims 1 through 3 of this patent application.

The process for manufacturing the wireless IC tag according to the present invention is a process to form a wireless IC tag by molding an outer shell body around a tag substrate by means of injection molding, characterized in that both upper and under surface of a tag substrate is held by supporting members so that the tag substrate is held in the central position of a die, the injection molding is then started while both lateral sides of the tag substrate being positioned by positioning members, then the supporting members and the positioning members are moved backward from the die on the way of performing injection, and the additional material is injected to continue the injection.

According to another embodiment of the process for manufacturing the wireless IC tag of the present invention as defined in claim 5 of this patent application, the injection molding is started while supporting and positioning the tag substrate so that the end portion of the tag substrate in the antenna axis line direction is placed opposite to the end portion of a columnar die cavity in the axial direction.

The die for molding the wireless IC tag according to the present invention is a die for molding the wireless IC tag in which an outer shell body is formed around a tag substrate by means of injection molding, characterized in that the die includes supporting members allowed to enter and exit the die and adapted to hold the upper and under surface of the tag substrate to thereby hold the tag substrate in the central position of the die cavity and positioning members allowed to enter and exit the die and adapted to position both lateral sides of the tag substrate, and round concave portions for forming the circumferential protrusions on the peripheries of both end portions of the wireless IC tag are formed on both end portions of the die cavity.

### BRIEF DESCRIPTION OF THE DRAWINGS

FIG. 1 is a front view of the wireless IC tag according to an example of the present invention.

FIG. 2 is a perspective view of a tag substrate to be embedded inside the wireless IC tag.

FIG. 3 is a perspective view of the wireless IC tag according to an example of the present invention.

FIG. 4 is a perspective view of a bottom tool of a die to be used for injection molding according to an example of the present invention.

FIG. 5 is a transverse cross-section showing the state of supporting and positioning the tag substrate in the die for injection molding according to an example of the present invention.

FIG. 6 is a schematic diagram showing an operational procedure of the supporting member for supporting a tag substrate in the die for injection molding according to an example of the present invention.

FIG. 7 is a front view of the wireless IC tag according to an example of the present invention, in which a tag substrate has been embedded in place.

FIG. 8 is a front view of the wireless IC tag according to an example of the present invention, in which a tag substrate has been embedded in an inclined state.

FIG. 9 shows an example of a mark indicating information on the manufacturing displayed on the outer surface of the wireless IC tag.

FIG. 10 is a perspective view showing the whole appearance of the wireless IC tag feeding machine of the vertical type.

FIG. 11 is a front view of a conventional columnar wireless IC tag and an end surface view of the columnar wireless IC tag for showing the interrelationship between said columnar wireless IC tag and the inner diameter of a releasing outlet provided to the IC tag feeding machine.

### DESCRIPTION OF THE REFERENCE NUMERALS

2: Columnar outer shell body
3, 4: Circumferential protrusion
5: Concave groove
6, 7: Small protrusion
10: Wireless IC tag
11: Tag substrate
20: Die for molding
21: Bottom tool
22: Bottom tool cavity
23: Resin-injecting outlet
24, 29: Supporting member
25: Positioning member
26: Circumferential concave
28: Top force
30: Top force cavity
31: Molten molding material
32: Void
33: Mark indicating information on manufacturing
40: IC tag feeding machine
42: Feed hopper
43: Vibratory alignment device
44: Inclined falling chute
45: Vertical falling passage

### DETAILED DESCRIPTION OF THE PREFERRED EMBODIMENTS

Now, the examples for carrying out the present invention will be described in the following with referring to the appended drawings. Note that, in the examples described below, although the wireless IC tag to be inputted to fresh concrete under being kneaded is exemplified, the wireless IC tag according to the present invention is not limited to such a wireless IC tag, and the wireless IC tag of the present invention can be applied to materials those which normally present in liquid, viscous and/or semi-solid state, e.g. molten thermoplastic resin materials, unhardened gypsum, etc.

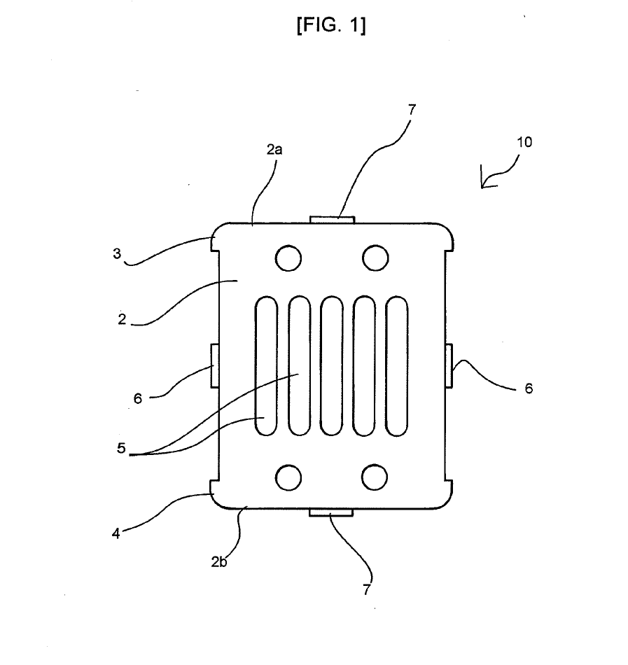

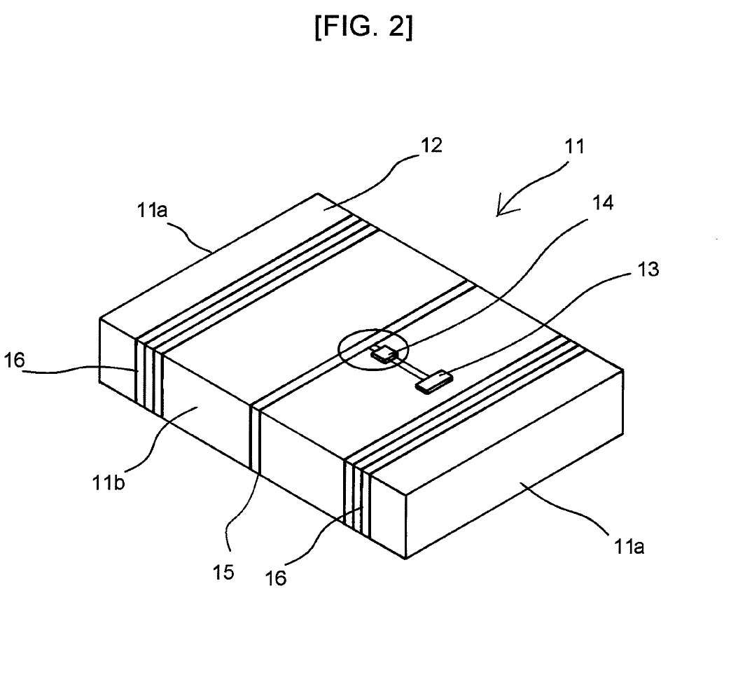

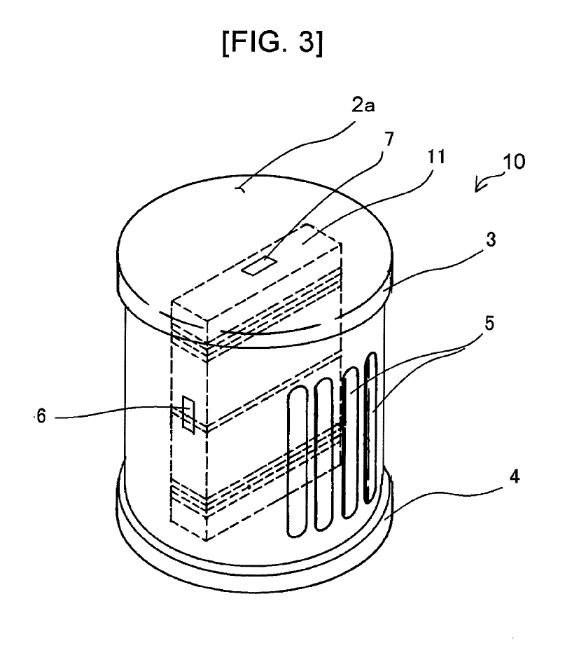

As shown in FIG. 1, the wireless IC tag 10 according to the present invention includes an outer shell body 2 generally shaped in a columnar form and functioning as a protective enclosure for the wireless IC tag, wherein circumferential protrusions 3, 4 are formed in a flange shape in the respective vicinities of the peripheries of both end portions in the axial direction of the outer shell body 2. Further, a plurality of shallow concave grooves 5 each extending in the axial direction are formed on the body section of the columnar outer shell body 2. The concave groove 5 is adapted to causes the material for building a construction to get inside the concave groove 5 and is then hardened there to thereby tightly bind to the wireless IC tag 10. As shown in FIG. 3, a tag substrate 11 shaped in a flat and rectangular form as shown in FIG. 2 is enclosed in the columnar outer shell body 2. Note that the outer shell body 2 is formed by means of injection molding, during which a tag substrate 11 to which an RFID module 17 is mounted and around which coils for antenna use 15, 16 are wound is enclosed in the outer shell body 2. This procedure will be described later in this specification. The portions represented with reference numerals 6 and 7 in FIG. 1 are burr-like small protrusions those which are caused in response to the resin-injecting outlets of the die when injection molding is implemented. In the drawing, these burr-like small protrusions are caused on the center of the both end surfaces and on both lateral sides of the body section, respectively. The outer shell body 2 is formed symmetrically relative to a plane including the axis line. In other ward, the rear shape of the outer shell body 2 is identical to the front shape of the same shown in FIG. 1. The ridges of the circumferential protrusions 3, 4 on the respective peripheries of both end portions of the outer shell body 2 are round chamfered and jointed in series to the both end surfaces 2a, 2b of the outer shell body. The peripheries of the circumferential protrusions 3, 4 are formed so as to have a diameter of slightly larger than the area of the burr-like small protrusion 6 caused on the body section. Note that, instead of round-chamfering the ridge of the circumferential protrusion, said circumferential protrusion may be formed in a disc-shaped flange.

As shown in FIG. 2, the tag substrate 11 to be enclosed inside the outer shell body is so structured that the tag substrate is mounted with an RFID tag module 17 comprising a flat and rectangular ferrite plate 12 mounted with a capacitor 13 and an IC chip 14 and is connected to the primary coil 15, and the secondary coil 16 working as an antenna for implementing transmission and reception of radio waves with the exterior is formed on said tag substrate by printing wiring technique. Said tag substrate 11 is positioned in the center of the outer shell body 2 so that the end portion 11a of the substrate in the axial direction of the primary and secondary coils 15, 16 opposes to the end portion in the axial direction of the columnar outer shell body 2. Consequently, radio signals for carrying out data writing and reading is transmitted and received in the direction heading the both end portions of the outer shell body 2 (the axis line direction of the outer shell body 2).

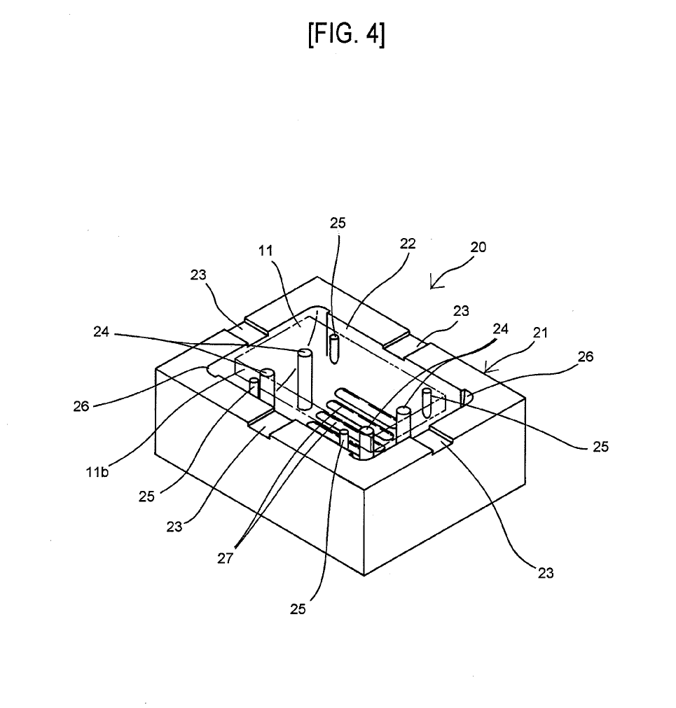

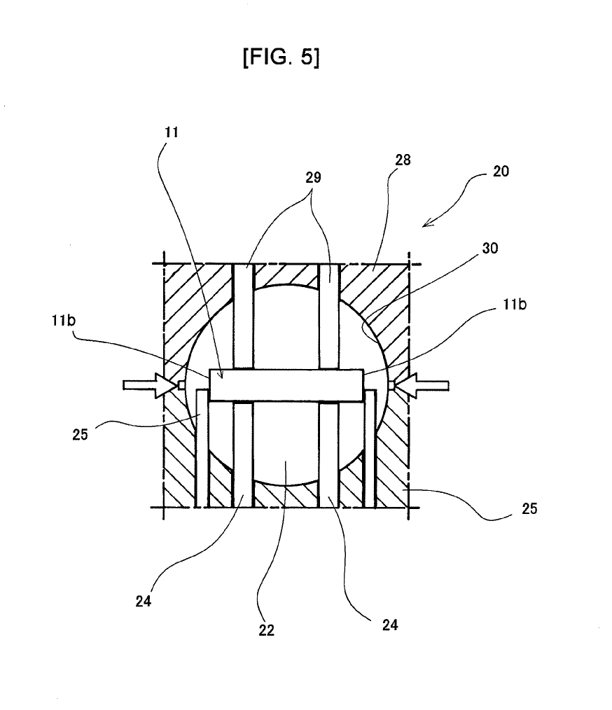

Now, the process for manufacturing the wireless IC tag according to the present invention and the die for molding to be used for said process will be explained with referring to FIGS. 4 through 6. Note that, in FIG. 5, the circumferential protrusions on both end portions of the outer shell body are not shown for convenience. A resin such as polypropylene is used as a material for forming the columnar outer shell body 2 (FIG. 1), and glass fibers and/or inorganic fillers may be mixed with such resin. Further, a glassy material for adjusting specific gravity may be added or kneaded to the resin so that said resin may be adjusted to a specific gravity value at which the wireless IC tags are appropriately dispersed in the material to be kneaded with the wireless IC tags. Note that an ideal range of the specific gravity for the wireless IC tags to be kneaded with a cement product is approximately 1.3 to 2.3. FIG. 4 is a perspective view showing a bottom tool 21 of a die 20 for the molding. The bottom tool has a bottom tool cavity 22 corresponding to the half periphery of the outer shell body 2, and four material(resin)-releasing outlets 23 are formed around the upper surface of the bottom tool 21. In the bottom tool 21, four supporting members 24 supporting the under surface of the tag substrate 11 are provided in such a manner that said supporting members enter and exit toward the bottom tool cavity 22, and four positioning members 25 allowed to enter and exit the die, those which are adapted to contact to the lateral side 11b of the tag substrate perpendicular to both end portions in the signal transmission/reception side of the tag substrate 11 supported by said supporting members 24 to thereby position the tag substrate 11 in the center of the cavity 22, are provided.

At both end portions of the die cavity 22, are formed circumferential concave grooves 26 corresponding to the half of the circumferential protrusions provided to both end portions of the tag outer shell body 2. Besides, on the bottom of the die cavity 22 corresponding to the body section of the tag outer shell body 2, are formed convex protrusions 27 corresponding to said concave grooves on the body section of the tag outer shell body as shown in FIG. 1. Though the configuration of the bottom tool of the die 20 for molding is as described above, the configuration of the top force 28 is same as that of the bottom tool 21 except for the positioning members. Specifically, four supporting members 29 (FIG. 4) allowed to enter and exit the die are provided to the top force 28, and convex protrusions (not shown) corresponding to said concave grooves on the body section of the outer shell body are formed on the bottom of the top force cavity 30.

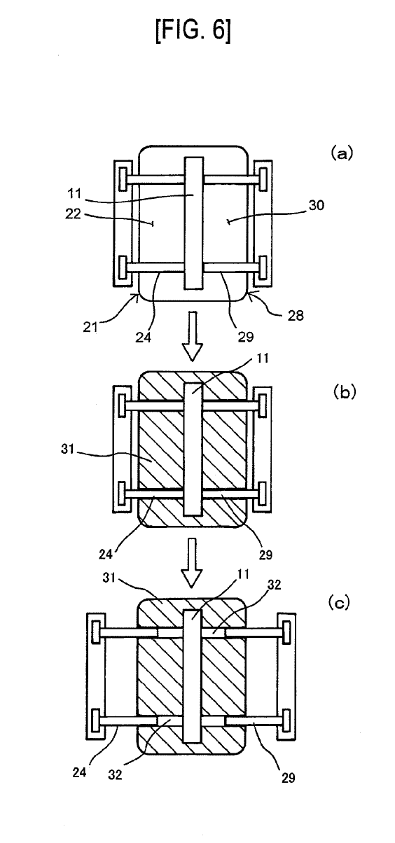

Now, the operation to form the wireless IC tag using said die 20 will be explained with referring to FIGS. 5 and 6. At first, the supporting member 24 in the bottom tool 21 is caused to move to a predetermined position in the die cavity 22, and a tag substrate 11 is then placed on the supporting member 24. At the same time, the positioning members 25 (not shown in FIG. 6) are also moved in the die cavity 22 to contact to both lateral portions 11b (the lateral sides perpendicular to the end portions at the signal transmission/reception side) of the tag substrate 11 as shown in FIG. 5, thereby positioning the tag substrate 11. Similarly, the supporting members 29 in the top force 28 are also moved inside the cavity 30 so that they contact to the tag substrate 11 from the upper side, thereby closing the top force 28 and the bottom tool 21 in tightly fitting state (FIG. 6(a)). At this time, the supporting members 24, 29 and the positioning members 25 are manipulated in such a manner that tag substrate 11 positions in the center of both cavities 30, 22 of the top force 28 and the bottom tool 21, and that the central line extending along the longitudinal direction of the tag substrate 11 correspond as much as possible to the center of the die cavity 22, 30. Then, a molten material 31 to be used for molding the outer shell body is injected into the die cavities 22, 30 (FIG. 6(b)). During a certain moment following to starting the injection, for example 4 seconds, the positions of the supporting members 24, 29 and the positioning members 25 are adjusted in order to avoid off-position and inclination of the tag substrate 11 from occurring due to failure in controlling the pressure or balance of the materials during the injection.

When a certain moment has passed after starting the injection, for example said period of 4 seconds has passed, the supporting members 24, 29 and the positioning members 25 are caused to move from the die cavities 22, 30 backward. However, the supporting and positioning members 24, 29, and 25 are configured to be caused to move backward to the halfway at most in the die cavities 22, 30, and therefore, those members 24, 29 and 25 are not pulled out completely from die 20. FIG. 6(c) shows the state when the supporting members 24, 29 are caused to move backward.

Continuously after moving the supporting members 24, 29 and the positioning members 25 backward from the die cavities 22, 30, a molten molding material 31 is filled into the cavities through the injecting outlet of the die by injection. A period of time required for this operation is for example 10.5 seconds more or less, and a period of time required for whole operation of from the start of injection up to the termination is 14.5 seconds more or less. The void 32 caused by the backward moving of the both members 24, 29 and 25 are filled with the additional material injected during the operation described above. Following to the termination of the injection of the molding material, the top force 28 and the bottom tool 21 are opened, and the wireless IC tag in the die cavity is taken out. Note that the movement of the supporting members 24, 29 and the positioning members 25 is controlled by for example an air cylinder of the die.

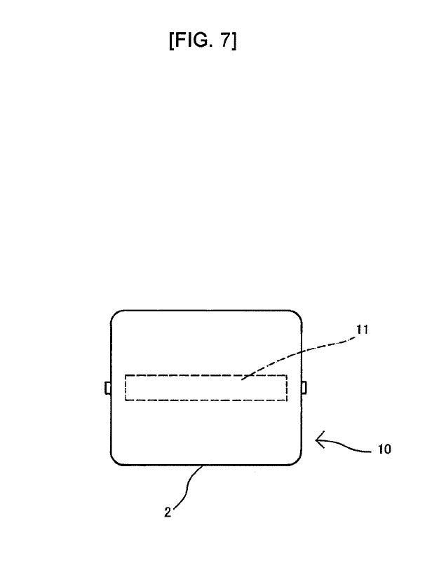

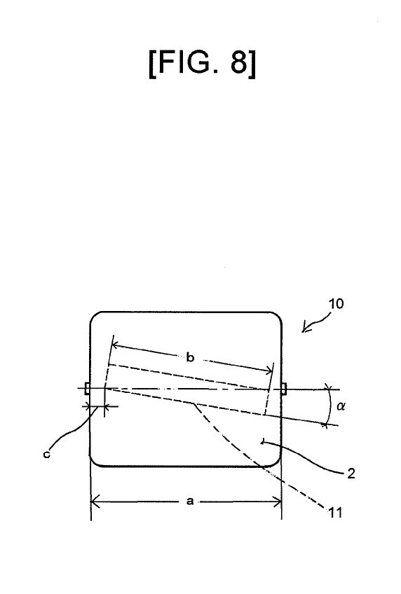

The best position and posture of the tag substrate to be fixed by the supporting members and the positioning members in the die cavity is those of the IC tag 10 shown in FIG. 7, wherein the axis line of the rectangular tag substrate coincides with the axis line of the die cavity. However, inclination or off-position to some extent is naturally accepted as far as falling within an allowable range. FIG. 8 shows that, although the center of the tag substrate 11 coincides with the center of the tag outer shell body 2, the axis line of the tag substrate 11 in the longitudinal direction is inclined at an angle of α relative to the central axis line of the columnar outer shell body 2. Specifically, when for example the length a of the columnar outer shell body 2 is 20 mm and the longitudinal length b of the tag substrate 11 is 17 mm, and the thickness between the end portion of the tag substrate 11 and the end portion of the outer shell body 2 is 1.5 mm, an allowable angle of the inclination (α) will be 16 degree more or less, and an allowable thickness c of the thin end portion will be 0.5 mm more or less. Note that said allowable angle a and said allowable thickness c vary depending on the size of the wireless IC tag 10, the material of the outer shell body 2 and so on.

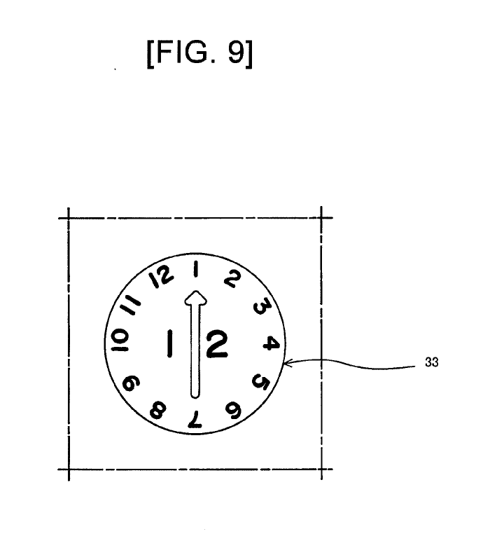

On the cavity wall surfaces of the top force and the bottom tool of the die, convex protrusions (FIG. 4) corresponding to the elongate concave grooves (FIG. 1) on the body section of the IC tag are formed, and in addition thereto, various marks for indicating information on the manufacturing may be engraved in the concave or convex state. FIG. 9 shows an example of an engraved mark 33 formed on the cavity wall of the die, which indicates information on the manufacturing such as the year and month of manufacturing is displayed on the end surface of the outer shell body of the wireless IC tag. This example shows that the date of manufacturing of this IC tag is January in Heisei 12 (January, 2000). Naturally, any other indication may be engraved arbitrarily.

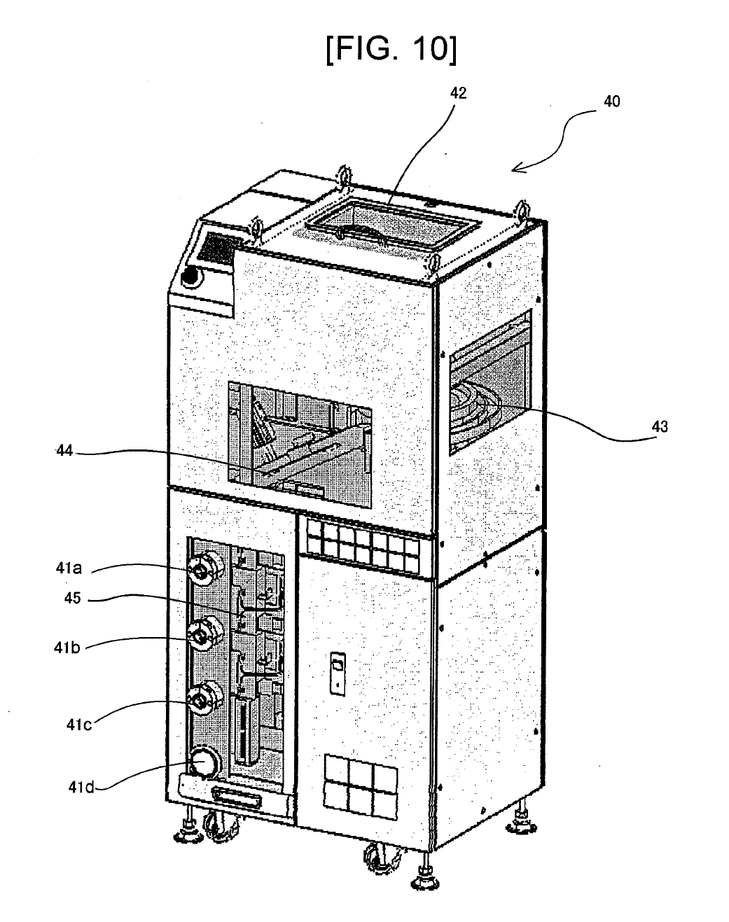

FIG. 10 is a perspective view showing the appearance from the front side of the IC tag feeding machine 40 which is useful for applying wireless IC tags according to the present invention. In this example, it is structured in a vertical feeding machine, in which a plurality of tag releasing outlets 41 are aligned vertically. A feed hopper 42 for feeding IC tags is provided to the top of the feeding machine, and hoses (not shown) are connected to each of the plural releasing outlets 41, respectively so that the wireless IC tags are released through the releasing outlets in turn to a vessel (not shown) for kneading fresh concrete. The columnar wireless IC tags are fed from the feed hopper 42 on the top to pass through the vibratory alignment device 43, where the direction of the wireless IC tag is arranged, and are falling down through the inclined falling chute 44 while keeping such a posture of the IC tag that the end surface thereof faces the falling direction. At the stopper device set in the vertical falling passage 45, data writing is executed in the data writing section (not shown) via radio communication, and the wireless IC tags are fed to the releasing outlets 41a through 41d locating at the lateral side in turn, whereby the wireless IC tags are thrown by virtue of compressed air through the hoses connected to the respective releasing outlets 41a through 41d onto the vessel for kneading fresh concrete.

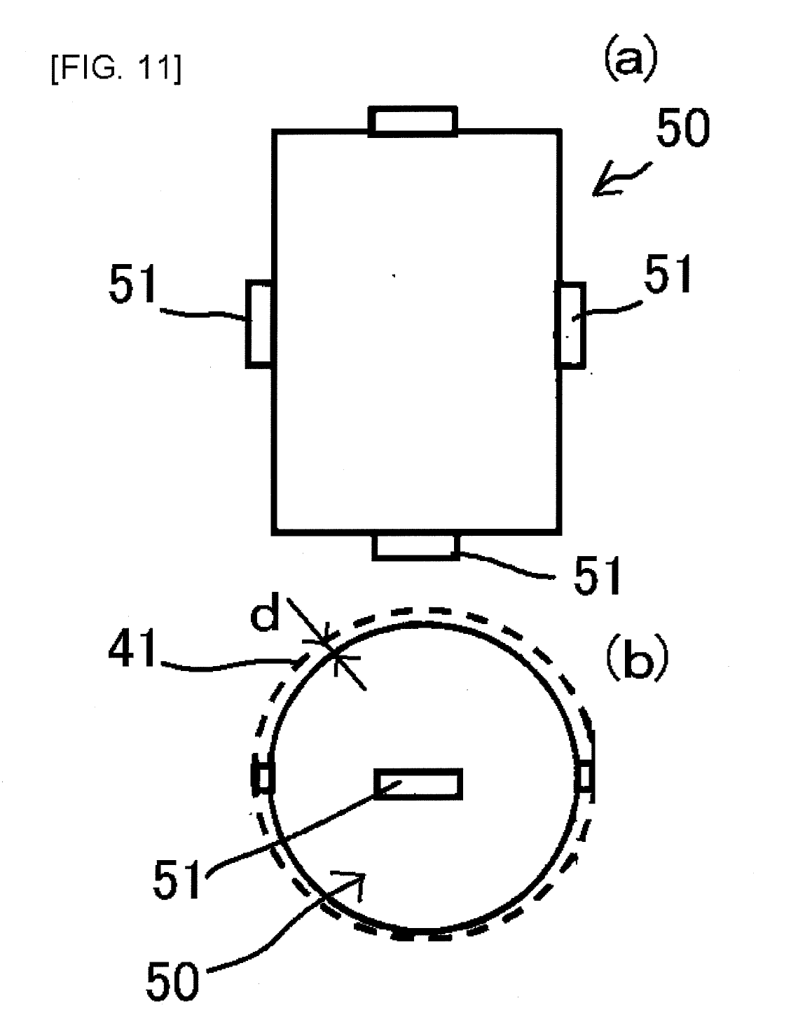

As described above, when the outer shell body of the IC tag is formed by injection molding, small protrusions in burr-like irregular forms are caused on the portions of the outer shell body, said portions correspond to the injecting outlet of molding material of the die. In the example shown in FIG. 11, small protrusions 51 caused correspondently to the injecting outlet of the die are formed on the centers of both end surfaces and two portions on the body section of the wireless IC tag 50, respectively. When the wireless IC tag 50 being in the state having such small protrusions is released from the releasing outlet of the IC tag feeding machine by virtue of compressed air, said small protrusions 51 and burr-like protrusions caused in the vicinity thereof are caught at the inner wall of the releasing outlet to get stuck there, or a gap d is caused in between the periphery of the body section of the wireless IC tag 50 and the inner wall of the releasing outlet 41 due to the small protrusions 51, thereby causing leakage of compressed air through the gap d, which may deteriorate the force to blow away the IC tag 50 and makes difficult to blow away the IC tag 50 to a far place.

In this respect, as shown in FIG. 1, the wireless IC tag 10 according to the present invention is characterized in that the circumferential protrusions 3, 4 each having an outer diameter becoming slightly larger than the area of the foresaid small protrusions 6 are formed in the each peripheries adjacent to both end portions of the columnar outer shell body, the wireless IC tag 10 slides through the inner wall of the releasing outlet 41 and the inner wall of the hose of the IC tag feeding machine 40 thank to occurrence of said circumferential protrusions 3, 4 to lightly contact with said inner wall of the releasing outlet 41 and said inner wall of the hose. Therefore, the small protrusions 6 on the tag body section caused corresponding to the injecting outlet of the die and the burr-like protrusions may not be caught to get stuck by the inner wall of the releasing outlet 41, whereby causing no failure of releasing the IC tags due to clogging of IC tags and leakage of air.

Note that, although the supporting members allowed to enter and exit the die for molding in the example described above is consisted of four members contacting to the upper and under surfaces of the tag substrate, the supporting member according to the present invention is not always limited to this embodiment. For example, the tag substrate may be supported by four supporting members provided in the bottom tool and one or two supporting members provided in the top force. Alternatively, the supporting members may be provided only to the bottom tool, but no supporting member may be provided to the top force. The positioning members may be installed not only at the lateral sides of the tag substrate but also at the end portions of the tag substrate in the longitudinal direction so that the positioning member contact to the said end portions to position the tag substrate.

According to the wireless IC tag of the present invention, the circumferential protrusions are formed on the peripheries of both end portions of the columnar body section, respectively. Said circumferential protrusions lightly contact to the inner wall of the carrying passage and the inner walls of the releasing outlets of the IC tag feeding machine, whereby reducing such occasion that the wireless IC tags get stuck and/or cause leakage of air in the carrying passage or at the releasing outlets in the IC tag feeding machine. Furthermore, because the tag substrate is accurately positioned in the outer shell body of the IC tag, no error is made in writing and reading radio data signals.

According to the process for manufacturing the wireless IC tag of the present invention, because the tag substrate is held in the central position in the die cavity by the supporting members and the positioning members for a period of from the starting of injection molding up to the halfway of the molding, the tag substrate is positioned in the central position in the outer shell body and accordingly, no error is made in writing and reading data by means of radio signals.

Because the die for molding the wireless IC tag according to the present invention includes the supporting members allowed to enter and exit the die and adapted to hold the tag substrate at the time of injecting a resin and the positioning members allowed to enter and exit the die and adapted to position the tag substrate in the die cavity, the tag substrate is positioned in the central position in the outer shell body, and accordingly, no error is made in writing and reading data by means of radio signals.

Besides, because the die cavity is formed so as to form the circumferential protrusions on the peripheries of both end portions of the IC tag, neither clogging of the IC tags supplied to the IC tag feeding machine nor failure of release thereof due to leakage of air is caused in the tag carrying passage and/or at the releasing outlets of the IC tag feeding machine.

1. A wireless IC tag comprising a tag substrate and a columnar outer shell body, wherein said tag substrate is enclosed in a columnar outer shell body and circumferential protrusions are formed respectively on the peripheries of both end portions of said columnar outer shell body.

2. A wireless IC tag according to claim 1 characterized in that the ridges of the circumferential protrusions are round chamfered.

3. A wireless IC tag according to claim 1 characterized by forming a plurality of concave grooves each extending in the axial direction are formed on the body section of the columnar outer shell body.

4. A wireless IC tag according to claim 1 characterized by engraving a mark indicating information on the manufacturing on the columnar outer shell body.

5. A process for manufacturing a wireless IC tag characterized by forming an outer shell body around a tag substrate by means of injection molding, wherein injection molding is implemented while supporting the upper and under surfaces of the tag substrate by supporting members so that the tag substrate is held in the central position in a die and positioning the both lateral sides of the tag substrate by positioning members, said supporting members and said positioning members are moved backward from the die on the way of performing the molding, and the molding material is then additionally injected the die to continue the injection molding.

6. A process for manufacturing a wireless IC tag according to claim 5 characterized in that the injection is started while supporting and positioning the tag substrate so that the end portion of the tag substrate in the antenna axis line direction is set opposite to the end portion of the columnar die cavity in the axial direction.

7. A die for molding a wireless IC tag characterized by forming an outer shell body around a tag substrate by means of injection molding, wherein said die includes supporting members allowed to enter and exit the die and adapted to support the upper and under surfaces of the tag substrate so that the tag substrate is held in the central position in the die cavity and positioning members allowed to enter and exit the die and adapted to position the both lateral side of the tag substrate, and circular concave portions for forming circumferential protrusions on the peripheries of the both end portions of the wireless IC tag are formed in the both end portions of the die cavity.

8. A wireless IC tag according to claim 2 characterized by forming a plurality of concave grooves each extending in the axial direction are formed on the body section of the columnar outer shell body.

9. A wireless IC tag according to claim 2 characterized by engraving a mark indicating information on the manufacturing on the columnar outer shell body.

10. A wireless IC tag according to claim 3 characterized by engraving a mark indicating information on the manufacturing on the columnar outer shell body.

11. A wireless IC tag according to claim 8 characterized by engraving a mark indicating information on the manufacturing on the columnar outer shell body.
